(19) United States
(12) Patent Application Publication
(10) Pub. No.: US 2014/0071464 A1
(43) Pub. Date: Mar. 13, 2014

(54) PRINTER AND CARD LOADER FOR PRINTER

(71) Applicants: Emmanuel Berthaud, Beaucouze (FR); Ludovic Moreau, Beaucouze (FR)

(72) Inventors: Emmanuel Berthaud, Beaucouze (FR); Ludovic Moreau, Beaucouze (FR)

(21) Appl. No.: 14/009,688

(22) PCT Filed: Mar. 19, 2012
(86) PCT No.: PCT/EP2012/054811

§ 371 Date: Nov. 26, 2013

(30) Foreign Application Priority Data
Apr. 4, 2011 (FR) 11/52854

(51) Int. Cl. G06K 15/16

(52) U.S. Cl. CPC G06K 15/16
USPC 358/1.6

(57) ABSTRACT

A card loader is intended to be fixed to a printer (23), the loader comprising at least one loading device intended to receive at least one card to be printed, and at least one driving device (16; 19). Each driving device (16; 19) makes it possible to transfer cards to be printed from a loading device to the printer (23). At least one driving device (16; 19) is movable to enable the printer (23), or a said loading device, to use, in order to manipulate a card, a space that is occupied by said driving device(s) (16; 19) when said driving device(s) (16; 19) transfer(s) a card to be printed to the printer.

The present invention concerns a card-loading device intended to be fixed to a printer, and to supply the printer with cards. The present invention applies in particular in the field of the thermal printing of plastic cards.

Printers are known provided with a loader loading cards to be printed and a receptacle intended to receive printed cards. Such printers perform operations of handling the cards during printing. For example, these printers are adapted to perform magnetic encoding on the cards and to print images and text on these cards. It is considered that magnetic encoding, or any operation aimed at applying a processing to the cards by the printer, is a printing operation.

Such operations require a relative movement, in particular in translation, between the card and the module or modules of the printer performing these operations. The loader and/or the receptacle being disposed so as to be juxtaposed with the space required for this manipulation of the cards by the printer, the size of these printers is relatively great.

It is desirable to overcome these various drawbacks of the prior art.

It is in particular desirable to provide a solution that reduces the size of a printer/card loader assembly compared with the solutions of the prior art.

It is in particular desirable to provide a solution that reduces such a size when several card loaders are used to feed the printer with cards to be printed.

It is in particular desirable to provide a solution that facilitates the mounting of such a card loader on the printer.

It is in particular desirable to provide such a solution that is suitable for supplying cards to be printed to the printer and receiving, in a receptacle, cards printed by the printer.

It is in particular desirable to provide a solution that is simple to implement and is effective in terms of cost.

The invention concerns a card loader intended to be fixed to a printer, said loader comprising at least one loading device intended to receive at least one card to be printed, and at least one driving device, each driving device transferring cards to be printed from a loading device to said printer. The card loader is such that at least one said driving device is movable in order to enable the printer, or a loading device, to use for manipulating a card a space that is occupied by said driving device(s) when said driving device(s) transfer(s) a card to be printed to the printer.

Thus the size of the printer/card loader assembly is reduced compared with the solutions of the prior art. This is because the movements of the driving device release spaces that are used either by a loading device other than the one to which the moved driving device relates, or by the printer for manipulating cards. The loader and/or printer are therefore more compact. This is because the dimensions of the printer can thus be reduced by a volume equal to the space released in the loader by movement of the driving device.

According to a particular embodiment, the card loader comprises: a first loading device intended to store a plurality of cards to be printed; a second loading device intended to receive, one by one, cards to be printed; a first driving device for transferring cards to be printed from the first loading device to said printer; a second driving device for transferring cards to be printed from the second loading device to said printer. The card loader is such that the first and second driving devices are movable so as to enable the printer, in order to manipulate a card to be printed during an operation performed by said printer, to use said spaces occupied by the first and second driving devices.

Thus, in a configuration with two card loading modes, the size of the printer is reduced.

According to a particular embodiment, the card loader comprises: a first loading device intended to store a plurality of cards to be printed; a second loading device intended to receive, one by one, cards to be printed; a first driving device for transferring cards to be printed from the first loading device to said printer; a second driving device for transferring cards to be printed from the second loading device to said printer. The card loader is such that the first or second driving device is movable in order to enable the other driving device to use said space that is occupied by the first or respectively second driving device in order to transfer a card to be printed to the printer.

Thus, in a configuration with two card loading modes, the size of the loader is reduced.

According to a particular embodiment, the first and second loading devices are substantially superimposed.

Thus the saving in size is increased.

According to a particular embodiment, the first and second driving devices are rollers.

According to a particular embodiment, the first driving device is a roller: able to be positioned in a first position, in which the first driving device is rotated in order to transfer a card to be printed from the first loading device to the printer; and able to be positioned in a second position in which the first driving device moves the cards to be printed, stored in the first loading device, away from a card transfer path.

According to a particular embodiment, the second driving device is a roller associated with at least one other roller and is: able to be positioned in a first position, in which the second driving device is rotated and is coupled to said other roller or rollers in order to transfer a card to be printed from the second loading device to said printer; and able to be positioned in a second position in which the second driving device is decoupled from said other roller or rollers.

According to a particular embodiment, the card loader is such that it also comprises a receptacle device intended to receive cards printed by the printer, and the movable driving device or devices is or are movable to enable the printer to transfer printed cards to the receptacle device.

According to a particular embodiment, the receptacle device is superimposed on said loading device or devices.

Thus the saving in size is increased.

The invention also concerns a printer provided with a card loader as previously mentioned.

According to a particular embodiment, the printer comprises a card processing module adapted in order, when said module performs a processing operation on a card to be printed, to manipulate the card to be printed using a space that is occupied by at least one driving device of said card loader when said driving device transfers a card to be printed to the printer.

The features of the invention mentioned above, as well as others, will emerge more clearly from a reading of the following description of an example embodiment, said description being given in relation to the accompanying drawings, among which:

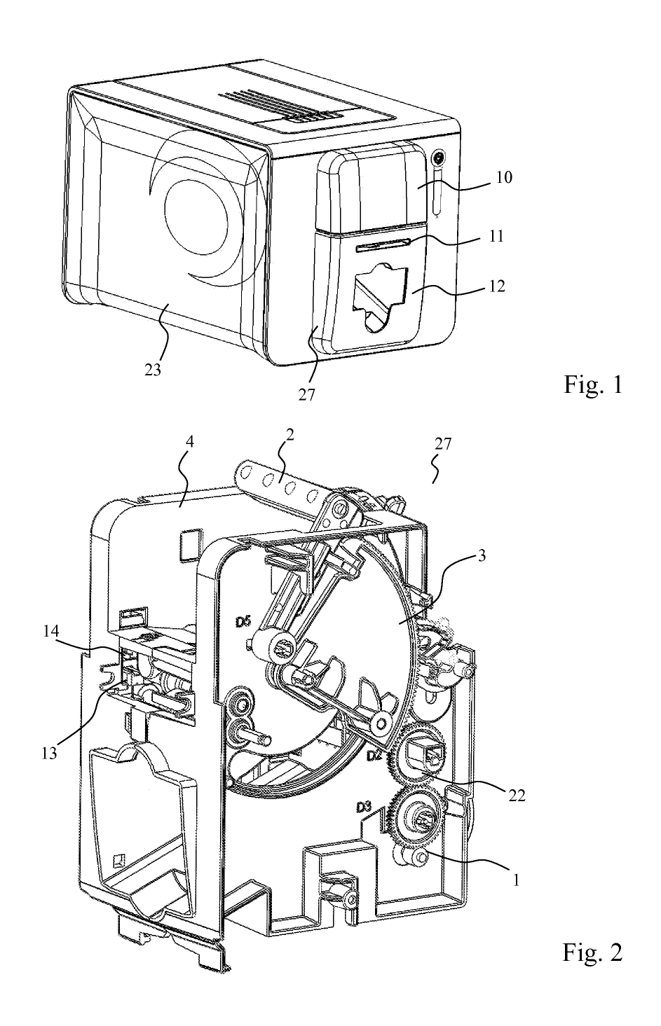

FIG. 1 illustrates a printer provided with a card loader, according to an embodiment of the present invention;

FIG. 2 illustrates the card loader in a perspective view;

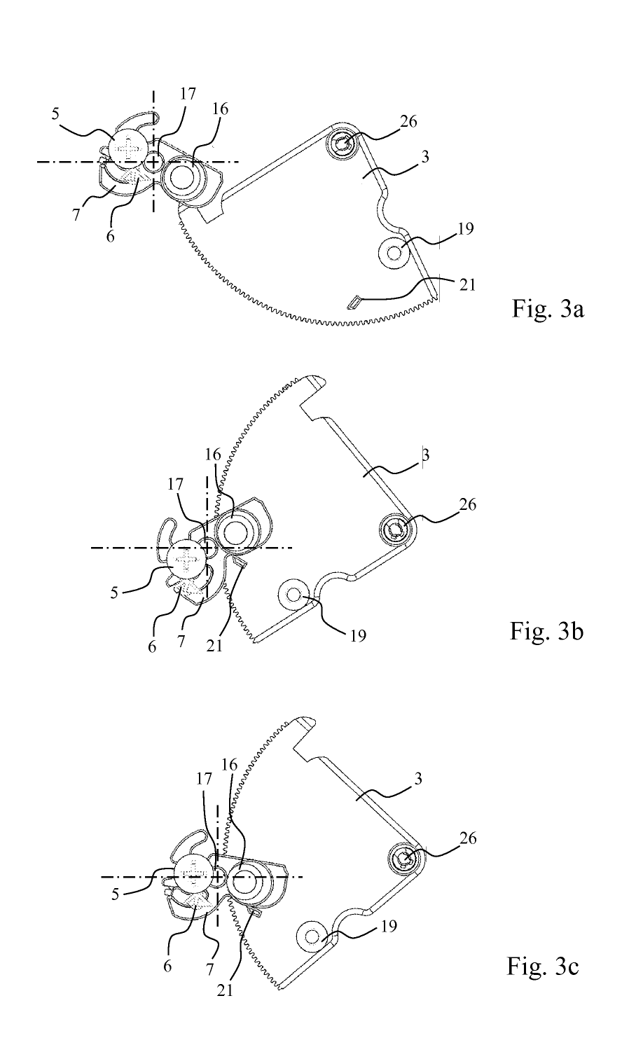

FIGS. 3a, 3b and 3c illustrate various positions adopted by driving devices of the card loader;

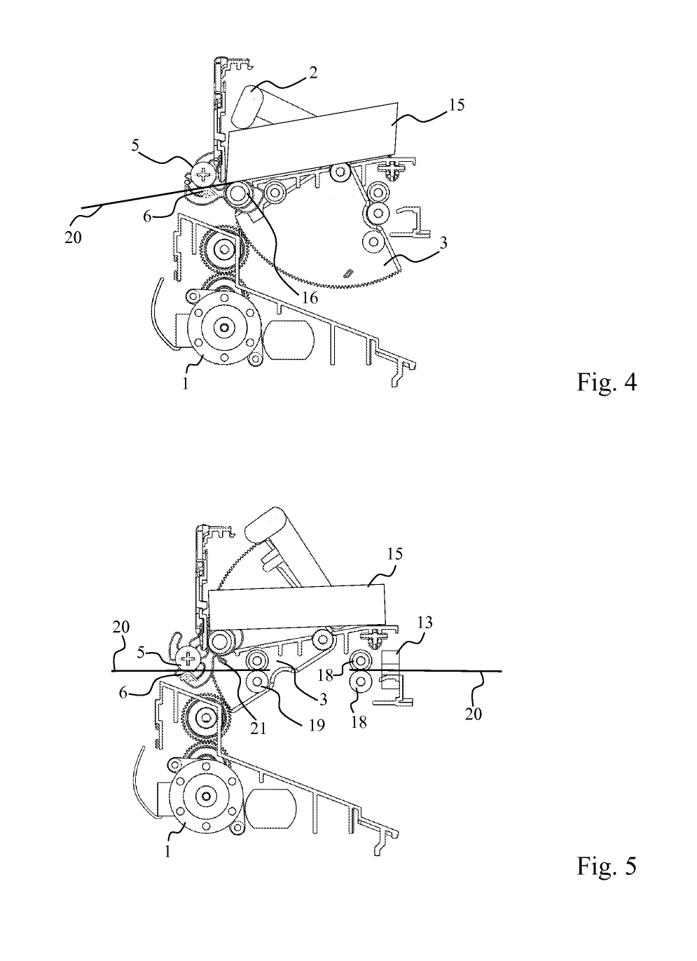

FIG. 4 illustrates, in a view in cross-section, the card loader, when it supplies to the printer a card to be printed from a first card loading device;

FIG. 5 illustrates, in a view in cross-section, the card loader, when it supplies to the printer a card to be printed from a second card loading device;

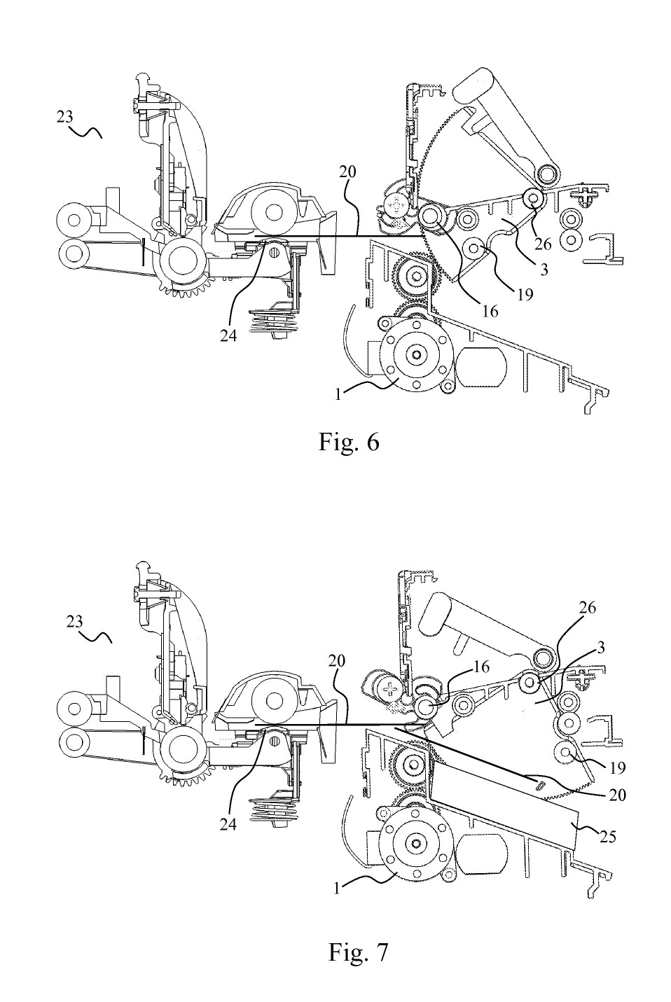

FIG. 6 illustrates, in a view in cross-section, a printing module of the printer and a card loader, when the printing module performs a card manipulation operation;

FIG. 7 illustrates, in a view in cross-section, the printing module of the printer and the card loader, when the printer transfers a printed card to a receptacle of the card loader.

So as to reduce the size of an assembly consisting of a printer and a card loader intended to supply the printer with cards to be printed, it is proposed to use card driving devices that are movable. This is because, so as to feed the printer with cards to be printed, the printer has driving devices, such as rollers, to make it possible to transfer the cards to be printed to the printer. It is therefore proposed that these driving devices be movable so as to enable the printer to use, in order to manipulate a card to be printed, a space that is occupied by these driving devices when they transfer a card to be printed to the printer.

In the same way, when the loader has several loading devices, the movement of the driving devices associated with one of these loading devices enables the other to use the space released in order to transfer a card to be printed to the printer.

Such adapted movements of the driving devices can also make it possible to reduce the space requirement relating to the transfer, by the printer, of a printed card to a receptacle of the card loader.

By virtue of the movement of these driving devices in a suitable manner as the card is loaded and printed, the overall size of the printer/card loader assembly is reduced.

This principle will be detailed below for an embodiment of the invention, other arrangements being possible without departing from the scope of the present invention.

FIG. 1 illustrates a thermal printer 23 for plastic cards, provided with a card loader 27. The card loader 27 comprises at least one first card loading device 10. In a particular embodiment, the card loader 27 comprises a second card loading device 11.

Preferentially, as shown in FIG. 1, the first card loading device 10 is intended to store a plurality of cards to be printed. The cards to be printed are thus stacked in the first card loading device 10. In addition, the second card loading device 11 is intended to receive, one by one, cards to be printed.

Preferentially, the first 10 and second 11 loading devices are substantially superimposed.

Preferentially, as shown in FIG. 1, the card loader 27 comprises a receptacle device 12 intended to receive cards printed by the printer 23. Preferentially, the receptacle device 12 is superimposed on the first 10 and second 11 loading devices.

Thus a user of the printer 23 can either effect a printing using a card stored in the first card loading device 10 or effect a printing using a card that he introduces, by means of a slot, into the second card loading device 11. The user next recovers the printed card by means of an opening formed in the receptacle device 12. When a card to be printed has been introduced into a slot in the second loading device 11, the card loader 27 can be adapted so that this card, after printing by the printer 23, can be recovered via this slot.

FIG. 2 illustrates the card loader 27, according to a perspective view.

The card loader 27 comprises various elements mounted in a frame 4. The card loader 27 comprises in particular a selecting device 3. The selecting device 3 makes it possible to put first 16 and second 19 driving devices (not shown in FIG. 2) in predetermined positions according to the printing or loading operation under way, as detailed below in relation to FIGS. 3a, 3b and 3c. The first driving device 16 is associated with the first loading device 10 and makes it possible to transfer cards to be printed from the first loading device 10 to the printer 23. The second driving device 19 is associated with the second loading device 11 and makes it possible to transfer cards to be printed from the second loading device 11 to the printer 23. The first 16 and second 19 driving devices are preferentially rollers.

The card loader 27 also comprises a rotor 1 suitable for rotating the selecting device 3 in order to pass the driving devices 16 and 19 from one predetermined position to another. The motor 1 can drive the selecting device 3 by means of toothed wheels 22. The motor 1 is preferentially a stepping motor, which makes it possible to place the selecting device 3 precisely in predetermined positions. The presence in the card loader 27 of this motor 1, as well as at least one transport motor (not shown) for putting in action the first 16 and second 19 driving devices, makes it possible for the loader to function autonomously with respect to the printer 23. Assembly of the card loader 27 and printer 23 is thus facilitated.

Other arrangements are possible to pass the driving devices 16 and 19 from one predetermined position to another, in particular by using translation movements.

The first 10 and second 11 loading devices may be equipped with respective card-presence sensors 14 and 13. The card-presence sensor 13 makes it possible to detect that a card to be printed is introduced into the second loading device 11, and the card-presence sensor 14 makes it possible to detect that at least one card to be printed is stored in the first loading device 10.

The card loader 27 may also comprise a card-cleaning device, as well as a card-thickness gauge for making printings on cards of different thicknesses.

As shown in FIG. 2, the first loading device 10 comprises a weight 2, the movement of which is described below in relation to FIGS. 4 to 7.

FIGS. 3a, 3b and 3c illustrate various positions adopted by the driving devices 16 and 19 by the action of the selecting device 3. As shown in FIGS. 3a, 3b and 3c, the driving device 19 is mounted on the selecting device 3. Thus, when the selecting device 3 is rotated about an axis 26, a movement of the driving device 19 takes place.

The selecting device 3, by action of the motor 1, makes it possible to pass the driving devices 16 and 19 into the following predetermined positions:

a first position, as shown in FIG. 3a, in which the driving devices 16 and 19 are positioned so as to make it possible to transfer a card to be printed from the first loading device 10 to the printer 23;

a second position, as shown in FIG. 3b, in which the driving devices 16 and 19 are positioned so as to make it possible to transfer a card to be printed from the second loading device 11 to the printer 23; and

a third position, as shown in FIG. 3c, in which the driving devices 16 and 19 are positioned so as to enable the printer 23 to use a space that is occupied by the driving device 16 and/or the driving device 19 in the first and second positions, that is to say the space occupied by these driving devices 16 and 19 when a card to be printed is transferred to the printer 23.

In the embodiment detailed below, the first position, as shown in FIG. 3a, is also a position in which the driving devices 16 and 19 are positioned so as to enable the printer 23 to transfer a printed card to the receptacle device 12. In a variant embodiment, a fourth position can be defined, in which the driving devices 16 and 19 are specifically positioned so as to enable the printer 23 to transfer this printed card to the receptacle device 12.

The selecting device 3 comprises a control entity 21 for rotating a switching lever 7, on which the first driving device 16 is mounted, about an axis 17.

In the first position, as shown by FIG. 3a, the control entity 21 is not in contact with the switching lever 7. The switching lever 7 is therefore in the low position, by gravity, and held in position by a stop (not shown). In the second position, as shown by FIG. 3b, the control entity 21 is in contact with the switching lever 7. The switching lever 7 is therefore in the high position and held in position by the pressure exerted by the control entity 21. In the third position, as shown by FIG. 3c, the control entity 21 is also in contact with the switching lever 7. The switching lever 7 is however in an intermediate position and is held in position by the pressure exerted by the control entity 21.

The interaction of the selecting device 3 and the other elements of the card loader 27, to make it possible to place the driving devices 16 and 19 in the positions mentioned above, is described below in relation to FIGS. 4 to 7.

FIG. 4 illustrates, in a view in cross-section, the card loader 27 when it supplies to the printer 23 a card to be printed from the first loading device 10. The motor 1 then drives the selecting device 3 in order to reach the position shown in FIG. 3a.

In this operating mode of the loader 27, the selecting device 3 is put in the low position by the action of the motor 1 and rotation about the axis 26. The switching lever 27 pivots about the axis 17. A cleaning roller 5 and a card switching axis 6 are also disposed on the switching lever 7, in counterweight to the first driving device 16 with respect to the axis 17, the first driving device 16 being heavier than the assembly formed by the cleaning roller 5 and the switching axis 6.

When the selecting device 3 is brought into the low position, the control entity 21 releases the pressure on the switching lever 7. Thus the first driving device 16 descends and the assembly formed by the cleaning roller 5 and the switching axis 6 rises, by rotation about the axis 17. In a variant embodiment, such a return movement can be achieved by means of an elastic element, such as a spring.

In addition, when the selecting device 3 rotates downwards, the weight 2 puts under pressure a packet of cards 15 stored by the first loading device 10, for better adhesion on the first driving device 16. In the other positions of the selecting device 3, as shown in FIGS. 3b and 3c, the weight 2 is lifted. In these positions, the selecting device 3 exerts a pressure on an arm supporting the weight 2, which has the effect of lifting the weight 2 of the packet of cards 15. In a variant embodiment, the weight 2 can be replaced by a lever exerting a pressure on the packet of cards 15 by means of an elastic mechanism, such as a spring.

The card to be printed, placed on the bottom of the packet of cards 15, is then facing an opening adjusted by the card thickness gauge. The first driving device 16 is then rotated by a card transport motor (not shown). The card to be printed 20 is moved in order to be transferred to the printer 23. This card to be printed 20 passes between the cleaning roller 5 and the switching axis 6 in order to be cleaned. Before the card to be printed 20 has completely left the first driving device 16, it is taken by the transport system of the printer 23, which continues to move it forward until it leaves the card loader 27. The loading operation is then terminated.

FIG. 5 illustrates, in a view in cross-section, the card loader 27 when it supplies to the printer 23 a card to be printed from the second loading device 11. The motor 1 then drives the selecting device 3 in order to reach the position shown in FIG. 3b.

The selecting device 3 is put in the high position by action of the motor 1 and rotation about the axis 26. The control entity 21 then bears on the switching lever 7 and forces it to tilt about the axis 17. Thus the first driving device 16 rises and the assembly formed by the cleaning roller 5 and the switching axis 6 descends in order to be placed on the card transfer path used for transferring a card from the second loading device 11 to the printer 23. The packet of cards 15 is then raised by the first driving device 16 so as to move away from the card transfer path used for transferring a card from the second loading device 11 to the printer 23. Such an arrangement can also be used for moving the packet of cards 15 away from the card transfer path used by the printer 23 during a printing operation or when a printed card is transferred to the receptacle device 12.

Thus the first driving device 16 is movable so as to enable the second driving device 19 to use the space that is normally occupied by the first driving device 16 in order to transfer a card to be printed 20 to the printer 23. The transfer of the card to be printed can then be effected via this space released by movement of the first driving device 16.

The movement of the selecting device 3 places the second driving device 19, which is a roller in the embodiment detailed, under pressure against another roller 18 that corresponds to it in order to ensure transport of the card to be printed. Other rollers 18 can be used in supplement. The second driving device 19 is thus coupled to at least one other roller 18, unlike the positions in FIGS. 3a and 3c, in which it is decoupled therefrom.

The second driving device 19 is then rotated by a card transport motor (not shown). The card to be printed 20 is moved in order to be transferred to the printer 23 by means of the assembly formed by the transport rollers 18 and 19. Before the card to be printed 20 has completely left the second driving device 19, it is taken by the printer transport system 23, which continues to move it forward until it leaves the card loader 27. The loading operation is then terminated.

This position of the selecting device 3, and of the first 16 and second 19 driving devices, can be used to transfer a printed card from the printer 23 to the second loading device 11. The direction of rotation of the transport rollers 18 and 19 is then reversed. The user can thus recover the printed card via the slot previously used for introducing it.

Other arrangements are possible in which the second driving device 9 is movable to enable the first driving device 16 to use the space that is normally occupied by the second driving device 19 to transfer a card to be printed 20 to the printer 23. The transfer of the card to be printed can then be effected via this space released by the movement of the second driving device 19.

FIG. 6 illustrates, in view in section, a printing module of the printer and the card loader 27, when the printing module performs a card manipulation operation. The motor 1 then drives the selecting device 3 to reach the position shown in FIG. 3c. Such a printing module comprises for example a magnetic head 24 for performing a magnetic encoding.

The selecting device 3 is put in an intermediate position by action of the motor 1 and rotation about the axis 26. The control entity 21 then bears on the switching lever 7 and forces it to tilt about the axis 17. The first driving device 16 and the assembly formed by the cleaning roller 5 and the switching axis 6 are moved to enable the card, during manipulation by the printer 23, to enter the card loader 27 without striking the element, thus avoiding any printed-card defects that might be related to impacts during the transport of the card.

Thus the first driving device 16 is movable to enable the printer 23 to use, for manipulating the card, the space that is normally occupied by the first driving device 16 for transferring a card to be printed 20 to the printer 23. Such an arrangement significantly reduces the overall size of the printer 23.

Other arrangements are possible in which the second driving device 19 is movable to enable the printer 23 to use, for manipulating the card, the space that is normally occupied by the second driving device 19 for transferring a card to be printed 20 to the printer 23.

FIG. 7 illustrates, in a view in cross-section, the printing module of the printer and the card loader 27, when the printer transfers a printed card 20 to the receptacle device 12. The motor 1 then drives the selecting device 3 to reach the position shown in FIG. 3a.

In this configuration, the printer 20 effects a manipulation of the printed card 20 so as to transfer it to the receptacle device 12.

The first 16 and second 19 driving devices are positioned to enable the printer 23 to use the space that is normally occupied by the first 16 and second 19 driving devices 16 in order to transfer a card to be printed 20 to the printer 23.

The printed card 20, when it leaves the last roller of the printing module of the printer 23, falls into the receptacle device 12 and comes to be placed above a packet 25 of printed cards.

Any other card processing module can be used by the printer 23 instead of the printing module.

1. Card loader (27) intended to be fixed to a printer (23), said loader comprising at least one loading device (10; 11) intended to receive at least one card to be printed, and at least one driving device (16; 19), each driving device transferring cards to be printed from a loading device (10; 11) to said printer,
wherein at least one said driving device (16, 19) is movable to enable the printer (23) to use, for manipulating a card, a space that is occupied by said driving device or devices (16; 19) when said driving device(s) (16, 19) transfer(s) a card to be printed to the printer.

2. Card loader according to claim 1, further comprising:
a first loading device (10) intended to store a plurality of cards to be printed;
a second loading device (11) intended to receive, one by one, cards to be printed;
a first driving device (16) for transferring cards to be printed from the first loading device to said printer;
a second driving device (19) for transferring cards to be printed from the second loading device to said printer;
wherein that the first (16) and second (19) driving devices are movable to enable the printer (23), in order to manipulate a card during an operation performed by said printer, to use said spaces occupied by the first (16) and second (19) driving devices.

3. Card loader according to claim 2, wherein the first and second loading devices are substantially superimposed.

4. Card loader according to claim 2, characterised in that the first and second driving devices are rollers.

5. Card loader according to claim 4, wherein the first driving device (16) is a roller:
able to be positioned in a first position, in which the first driving device (16) is rotated in order to transfer a card to be printed from the first loading device (10) to the printer (23), and
able to be positioned in a second position, in which the first driving device (16) moves the printed cards (15), stored in the first loading device (10), away from a card transfer path.

6. Card loader according to claim 4, wherein the second driving device (19) is a roller associated with at least one other roller (18) and:
able to be positioned in a first position in which the second driving device (19) is rotated and is coupled to said other roller or rollers (18) in order to transfer a printed card from the second loading device (11) to said printer (23),
able to be positioned in a second position, in which the second driving device (19) is decoupled from said other roller or rollers (18).

7. Card loader according to claim 1, wherein it also comprises a receptacle device (12) intended to receive cards (25) printed by the printer, and in that the movable driving device or devices (16; 19) is or are movable to enable the printer (23) to transfer printed cards to the receptacle device (12) using said space occupied by said driving device or devices (16; 19) when said driving device or device(s) (16; 19) transfer(s) a card to be printed to the printer.

8. Card loader according to claim 7, wherein the receptacle device (12) is interposed on said loading device or devices (10; 11).

9. Printer (23) provided with a card loader according to claim 1.

10. Printer according to claim 9, wherein it comprises a card processing module adapted, when said module performs a processing operation on a card to be printed, to manipulate the card to be printed using a space that is occupied by at least one driving device (16; 19) of said card loader (27) when said driving device(s) (16; 19) transfer(s) a card to be printed to the printer.
